(19) United States
(12) Patent Application Publication
(10) Pub. No.: US 2008/0110241 A1
(43) Pub. Date: May 15, 2008

(54) Photo-induced sensitivity and selectivity of semiconductor gas sensors

(76) Inventors: Avner Rothschild, Cambridge, MA (US); Harry L. Tuller, Wellesley, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/985,502

(22) Filed: Nov. 15, 2007

Related U.S. Application Data
(62) Division of application No. 11/130,799, filed on May 17, 2005, now abandoned.
(60) Provisional application No. 60/572,310, filed on May 17, 2004.

(51) Int. Cl. G01N 9/00

(52) U.S. Cl. 73/31.06

(57) ABSTRACT

A selective gas sensor comprises a semiconducting substrate, a radiation source that directs narrowband radiation to the semiconducting substrate; and a plurality of electrodes coupled to the semiconducting substrate, whereby a gas is selectively sensed. A method of selectively sensing a gas comprises the steps of contacting the semiconducting substrate with a gas, directing narrowband radiation to the semiconducting substrate and sensing the resistance of the semiconducting substrate, thereby selectively sensing the gas.

### RELATED APPLICATIONS

This application is a divisional of U.S. application Ser. No. 11/130,799, filed on May 17, 2005, which claims the benefit of U.S. Provisional Application No. 60/572,310, filed on May 17, 2004. The entire teachings of the above applications are incorporated herein by reference.

### BACKGROUND OF THE INVENTION

Semiconductors are commonly used for gas sensing given their high sensitivity to many different vapor species, their simple construction and the ready ability to miniaturize devices in thin film form. Many applications using semiconductor gas sensors have been proposed and increasingly commercialized including automotive cabin air quality control, hazardous (explosive/toxic) gas alarms, process control in the food industry, medical diagnosis, and the like. Such semiconductor gas sensors are simpler in design and operation compared to alternatives, e.g., surface acoustic wave devices, and are more stable than polymer-based or electrochemical gas sensors.

Conventional semiconductor gas sensors employ heat to activate the chemical interactions that eventually lead to the sensor's response signal, and are well known to the art. However, these devices typically need to be heated to temperatures between 200-400° C. to insure sufficiently rapid kinetics. Prolonged operation at high temperatures typically leads to materials degradation and aging effects resulting in drift and long term stability problems, in addition to disadvantages of high power and thermal dissipation requirements, poor selectivity (i.e., it is difficult to detect a single gas with specificity or to distinguish multiple gases), and the like.

Some efforts in the field of machine olfaction (a.k.a. “electronic nose”) attempt to solve the selectivity problem by analyzing the signals obtained from multi-sensor arrays using pattern recognition and classification algorithms. However, the individual sensors in such arrays typically involve complex custom fabrication, e.g., employing different sensing materials, catalysts, special membranes and filters, or operating each sensor at a different temperature, and the like. These complex arrays further require laborious empirical calibration methods and can still have selectivity problems.

Attempts have been made to use broad band illumination of SnO₂ and In₂O₃ substrates to sense CO and NO₂ at ambient temperatures. However, these sensors continue to lack selectivity and require high-power light sources, e.g., mercury or xenon lamps, which are undesirable because of cost, size, power requirements, heat output, and the like.

Other attempts have been made using different materials and sensing methods but include disadvantages such as complex measurement methods (e.g., photocurrent multiplication, photovoltaic measurement, mechanical force measurement), lack of specificity for individual gases, and/or involve complex multilayered material structures, and the like.

Therefore, there is a need in the art for semiconductor gas sensors and sensing methods that can selectively detect gases, can operate at low (i.e., ambient) temperatures with low power/thermal dissipation requirements, and are simple to construct and operate.

### SUMMARY OF THE INVENTION

Selective gas sensors and sensing methods are disclosed herein that employ irradiation of semiconductors with light.

A selective gas sensor comprises a semiconducting substrate, a narrowband radiation source that directs narrowband radiation to the semiconducting substrate; and a plurality of electrodes coupled to the semiconducting substrate, whereby a gas is selectively sensed.

In some embodiments, a selective gas sensor, comprises a semiconducting substrate; a solid state radiation source coupled with the semiconducting substrate that directs narrowband radiation to the semiconducting substrate, and a plurality of electrodes coupled to the semiconducting substrate, whereby a gas is selectively sensed. The mean energy of the narrowband radiation is less than the band gap energy of the semiconducting substrate, and the narrowband radiation is selectively absorbed by a complex, the complex comprising the semiconducting substrate and the gas to be selectively sensed. In some embodiments, the solid state radiation source can be integrated with the semiconducting substrate.

A method of selectively sensing a gas comprises the steps of contacting the semiconducting substrate with a gas, directing narrowband radiation to the semiconducting substrate and measuring the resistance of the semiconducting substrate, thereby selectively sensing the gas.

In some embodiments, the method of selectively sensing a gas comprises the steps of contacting a semiconducting substrate with a gas, directing narrowband radiation to the semiconducting substrate from a solid state narrowband radiation source coupled with the semiconducting substrate, and measuring the resistance of the semiconducting substrate, thereby selectively sensing the gas. The mean energy of the narrowband radiation is less than the bandgap energy of the semiconducting substrate, and the narrowband radiation is selectively absorbed by a complex, the complex comprising the semiconducting substrate and the gas. In some embodiments, the solid state radiation source can be integrated with the semiconducting substrate.

Such sensors and sensing methods solve many problems existing in the art. For example, by employing narrowband radiation instead of heat, power and heat dissipation requirements and thus sensor complexity can be reduced. Because the sensor can be operated at room temperature and without high electric fields, it can experience less heat and field induced aging, and can operate more safely in combustible environments. Further, by operating at room temperature, the sensor can experience less of the temperature sensitivity typically associated with semiconductor gas sensors. By employing narrowband instead of broadband radiation, a gas can be selectively sensed, and thus different gases can be distinguished. Further, the narrowband radiation source can be, for example, a low cost, low power source such as a light emitting diode (LED) or a laser diode, which can, in some embodiments be integrated with the semiconducting substrate. By employing a semiconducting substrate and electrodes, the sensor can be simple to construct and operate compared to the prior art. Furthermore, the combination of selectivity, low power and heat dissipation, and simplicity of construction and operation, arrays of sensors can be constructed which can allow selective detection of multiple gases by such arrays.

### BRIEF DESCRIPTION OF THE DRAWINGS

FIG. 1 depicts an embodiment of a selective semiconductor gas sensor 100 of the invention.

FIG. 2 depicts complex 200 at sensor 100 comprising molecules of a gas 202 that is to be sensed and semiconducting substrate 112.

FIG. 3 depicts an embodiment of sensor 100, labeled as sensor 300, wherein narrowband radiation source 114 can be integrated with semiconducting substrate 112.

FIG. 4A depicts sensor embodiment 400, which includes at least two gas sensing sites 402 and 404, wherein electrodes are coupled to the semiconducting substrate to selectively sense at least one distinct gas at each site.

FIG. 4B depicts sensor embodiment 400, which includes at least two gas sensing sites 402 and 404, each site being illuminated by individual light sources 114 and 114′ wherein electrodes are coupled to the semiconducting substrate to selectively sense at least one distinct gas at each site.

FIG. 4C depicts embodiments where more than two distinct gas sensing sites can be employed, for example, as an array 412 of sites 414, 416, 418, and 420.

FIGS. 5A-C depict sensor embodiment 500 equipped to sequentially direct distinct narrowband radiation at sensing site 422, whereby distinct gases can be sensed as a function of time. In FIG. 5A narrowband radiation of a first mean wavelength λ(1) can be directed during a first time interval T(1), in FIG. 5B a second mean wavelength T(2) can be directed during a second time interval λ(2). In FIG. 5C, optional third mean wavelength λ(3) can be directed during optional third time interval T(3).

FIGS. 6A-C are schematic presentations of the effect of the ambient gas atmosphere on the energy band diagram of thermally activated semiconducting gas sensors:

FIG. 6A, n-type semiconductor in clean air; FIG. 6B, n-type semiconductor with reducing gases in air; and FIG. 6C, n-type semiconductor with oxidizing gases in air.

FIG. 7 (Prior art) depicts gas response of SnO₂ to 100 ppm NO₂ with (right-hand-side) and without (left-hand-side) broadband illumination at 25° C. and 0% relative humidity. Conductance (G) and contact potential difference (CPD) measurements are shown on the bottom and top curves, respectively.

FIGS. 8A-C depicts schematic models of different routes for photo-activation of charge transfer interactions between an n-type semiconductor and various gas adsorbates that can promote the sensitivity to the corresponding gases. FIG. 8A is a graph of super bandgap illumination (λ<hc/E_{g}) leading to electron-hole separation in the surface depletion layer; FIG. 8B is a graph of sub-bandgap illumination (λ>hc/E_{g}) leading to electron excitation from the valence band into an oxidizing state (Ox_{II(ad)}⁻); and FIG. 8C is a graph of sub-bandgap illumination (λ>hc/E_{g}) leading to electron excitation from an intermediate reducing state (ReO_{II(ad)}⁻) into the conduction band. E_{C}=conduction band edge, E_{V}=valence band edge, E_{F}=the Fermi energy level.

FIGS. 9A, 9B are respective schematic illustrations of the joint density of states for two different oxidizing gas adsorbates (Ox_{(ad)}^{I} and Ox_{(ad)}^{II}) at two different wavelengths (I and II). The length of the arrows represents the photon energy, and the shaded area is proportional to the joint density of states.

FIG. 10A, 10B (Prior art) depict spectral dependence of the quantum yield of photoadsorption of oxygen (1); hydrogen (2), and methane (3) on (FIG. 10A) TiO₂ and (FIG. 10B) CeO₂. The photoadsorption of oxygen was studied at T=100 K, whereas hydrogen and methane at T=293 K.

FIG. 11A shows an environmental chamber system including a Kelvin probe apparatus that enable Surface Photovoltage Spectroscopy (SPV) measurements (using monochromatic illumination source) under controlled gas atmospheres.

FIG. 11B (Prior art) shows an SPV spectrum of an oxidized TiO₂ film and the interpretation of the results in terms of a simplified energy band diagram.

### DETAILED DESCRIPTION OF THE INVENTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

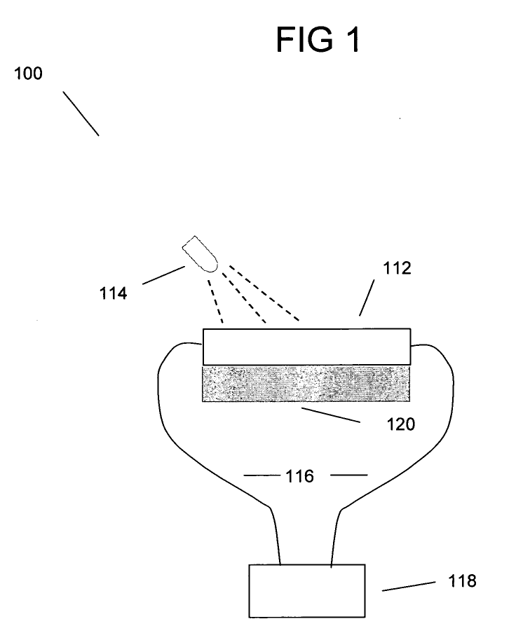

FIG. 1 depicts an embodiment of a selective semiconductor gas sensor 100 of the invention. Sensor 100 includes semiconducting substrate 112, narrowband radiation source 114; and plurality of electrodes 116. Optional controller 118 can be coupled to electrodes 116, whereby electrical properties (e.g., resistance) of semiconducting substrate 112 can be measured, whereby a difference in a measured property upon exposure to a sample can indicate the presence of a gas.

Semiconducting substrate 112 can include any semiconductor known to the art, for example, organic semiconductors, inorganic semiconductors, semiconductors including inorganic and organic components, and the like.

For example, organic semiconductors can include organic materials known to have conducting or semiconducting properties under appropriate doping conditions, e.g., carbon nanotubes; fullerenes (e.g., C60, C70, and the like); conjugated oligomers and polymers, e.g., polyacetylene, polythiophene, polyphenylene, poly(para-phenylene)vinylene, poly(para-pyridyl)vinylene, polyaniline, polypyrrole, and the like;

Typically, organic semiconductors will be doped according to methods well known in the art; see, for example “Organic Semiconductors” Gutmann, L.; Lyons, L. R.E. Krieger Pub. Co., Malabar, Fla., 1981; “Organic Molecular Semiconductors: Structural, Optical, and Electronic Properties of Thin Films” Zahn, D. R. T.; Kampen, T. U.; Scholz, R. (NY: John Wiley and Sons) 2004.; and “Handbook of Conducting Polymers” Skotheim, T. A.; Elsenbaumer, R.; Reynolds, J. R.; Eds. Marcel Dekker, New York, 2^{nd} Ed, 1997. The entire teachings of these documents are incorporated herein by reference.

Semiconducting substrate 112 can include any inorganic semiconductor known to the art, typically selected from family II-VI, III-V or column IV semiconductors/insulators, metal oxides, sulfides, selenides, and nitrides. For example, semiconducting substrate 112 typically includes, or more preferably consists of, an inorganic semiconductor selected from CdTe, CdSe, ZnS, AlGaN, InGaN, GaP, InP, InAsP, Ge, Cr₂₋ₓTiₓO₃, SiC, MoO₃, CaTiO₃, (La,Sr)FeO₃, (La,Sr)CoO₃, SnO₂, TiO₂, ZnO, WO₃, Fe₂O₃, In₂O₃, Ga₂O₃, SrTiO₃, BaTiO₃, CdS, GaN, GaAs, and Si. In some embodiments, semiconducting substrate 112 is SnO₂, TiO₂, ZnO, WO₃, Fe₂O₃, In₂O₃, Ga₂O₃, SrTiO₃, BaTiO₃, CdS, GaN, GaAs, or Si.

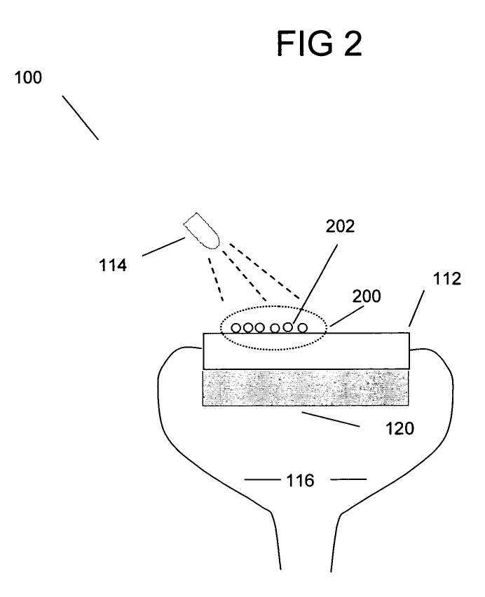

FIG. 2 depicts complex 200 at sensor 100 comprising molecules of a gas 202 that is to be sensed and semiconducting substrate 112. It is to be understood that complex 200, comprising molecules of a gas 202, is not part of sensor 100 but is depicted as an example of sensor 100 in operation. Without wishing to be bound by theory, it is believed that gas 202 can contact semiconducting substrate 112, e.g., be chemisorbed at semiconducting substrate 112, whereby complex 200 can absorb the narrowband radiation, e.g., the complex has at least one absorption maxima.

Narrowband radiation source 114 can be any source of electromagnetic radiation, typically light in a range from far infrared (e.g., from about 1200 micrometers) to ultraviolet (e.g., about 200 nanometers). As used herein, “narrowband” means that the radiation is a subset of the spectrum that is selectively absorbed by gas 202 and/or semiconducting substrate 112, typically as an absorption maxima of complex 200.

In some embodiments, narrowband radiation source 114 can be, for example, a filter (e.g., a filter, a grating, and the like) that can be coupled to a broadband source (e.g., solar radiation, xenon lamps, mercury lamps, and the like). In some embodiments, narrowband radiation source 114 is a solid state source, for example, a light emitting diode (LED), a laser (e.g., a laser diode), a quantum dot or quantum well, and the like. In some embodiments, narrowband radiation source 114 is a light emitting diode; in other embodiments, narrowband radiation source 114 is a laser. Solid state sources can be broadband or narrowband, typically narrowband, and can also be combined with a filter or grating to further select the radiation band.

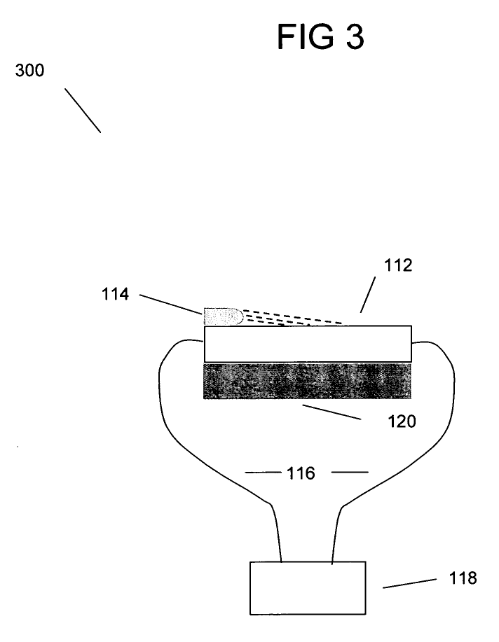

FIG. 3 depicts an embodiment of sensor 100, labeled as sensor 300, wherein narrowband radiation source 114 can be integrated with semiconducting substrate 112. For example, when narrowband radiation source 114 is filter or grating, the filter or grating can be attached to semiconducting substrate 112. In embodiments where narrowband radiation source 114 is a solid state source, for example, narrowband radiation source 114 can be a light emitting diode or laser diode that is attached to semiconducting substrate 112, or in some embodiments, narrowband radiation source 114 can be a light emitting diode or laser diode that is constructed in semiconducting substrate 112, e.g., when semiconducting substrate 112 is made of a semiconductor that can also be a light emitting diode.

Generally, the mean energy of the narrowband radiation from narrowband radiation source 114 is less than the bandgap energy of semiconducting substrate 112. In various embodiments, at least about 50%, 60%, 70%, 80%, 85%, 90%, 92%, 94%, 95%, 96%, 97%, 98%, 99%, 99.5%, or 99.9% of the energy of the narrowband radiation is less than the bandgap energy of semiconducting substrate 112.

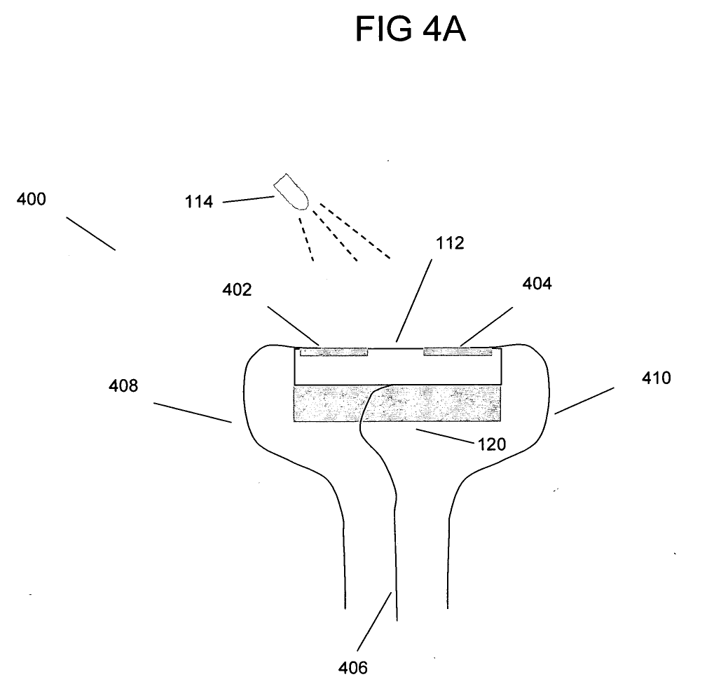

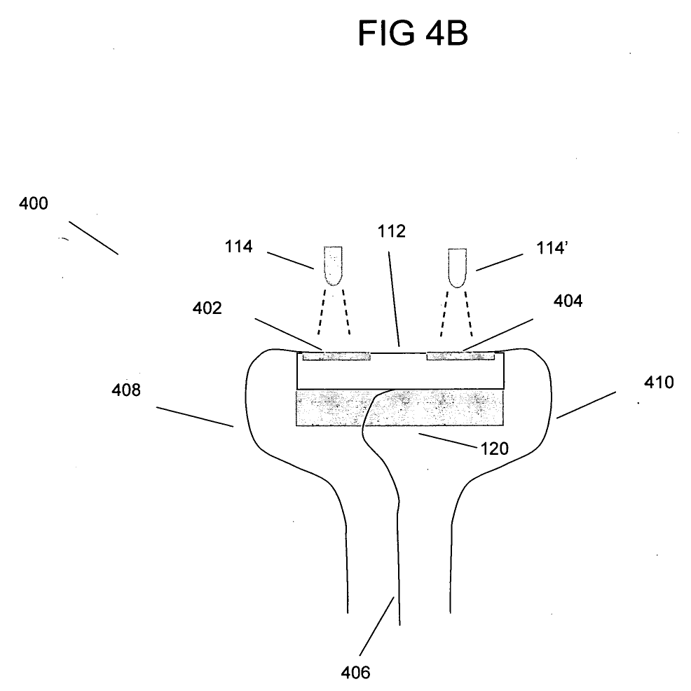

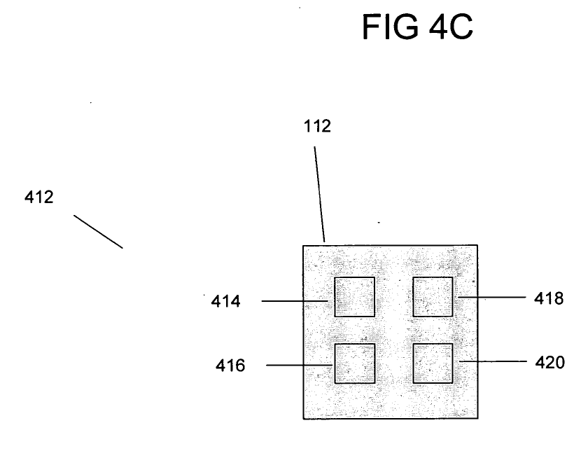

FIGS. 4A-C and 5A-C depict embodiments 400 and 500 of sensor 100 wherein the sensor can selectively sense a plurality, i.e., two or more distinct gases.

FIG. 4A depicts sensor embodiment 400, which includes at least two gas sensing sites 402 and 404, wherein electrodes are coupled to the semiconducting substrate to selectively sense at least one distinct gas at each site. For example, as depicted, a single ground/reference electrode 406 can be coupled to semiconducting substrate 112 and electrodes 408 and 410 can couple separately to gas sensing sites 402 and 404, respectively. Ground/reference electrode 406 can be coupled to semiconducting substrate 112 at its back surface, as shown in FIG. 4A, or in various embodiments can be coupled to any other point on semiconducting substrate 112.

In some embodiments, sites 402 and 404 selectively detect distinct gases because the composition of semiconducting substrate 112 is distinct at each site, for example, the same semiconductor has a different doping level at sites 402 and 404, or different semiconductors are employed at sites 402 and 404, or different catalysts are employed at sites 402 and 404, and the like.

In some embodiments, sites 402 and 404 selectively detect distinct gases because narrowband radiation source 114 directs distinct narrowband radiation to each gas sensing sites 402 and 404.

In typical embodiments, sites 402 and 404 selectively detect distinct gases because narrowband radiation source 114 directs distinct narrowband radiation to each gas sensing site 402 and 404, and the composition of semiconducting substrate 112 is distinct at each site.

FIG. 4B depicts sensor embodiment 400, which includes at least two gas sensing sites 402 and 404, each site being illuminated by individual light sources 114 and 114′ wherein electrodes are coupled to the semiconducting substrate to selectively sense at least one distinct gas at each site. This can provide for selective detection of different gases on the same substrate

FIG. 4C depicts embodiments where more than two distinct gas sensing sites can be employed, for example, as an array 412 of sites 414, 416, 418, and 420.

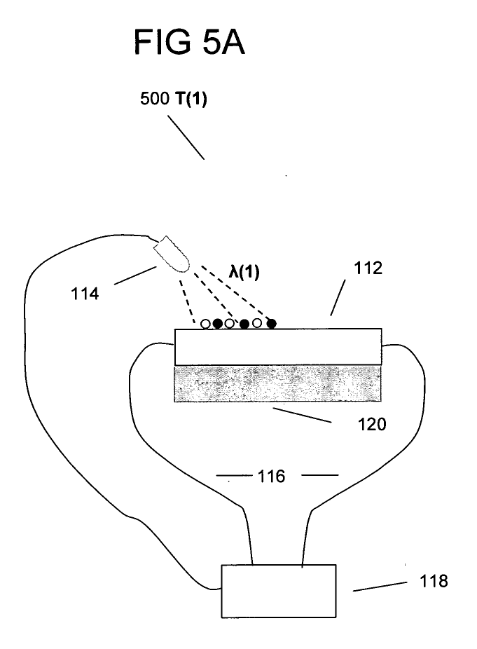

FIGS. 5A-C depicts sensor embodiment 500 wherein controller 118 is equipped to sequentially direct distinct narrowband radiation from a radiation source 114 to semiconducting substrate 112 and measures the resistance of the substrate through electrodes 116, whereby distinct gases can be sensed as a function of time. For example, in FIG. 5A narrowband radiation of a first mean wavelength λ(1) can be directed at semiconducting substrate 112 during a first time interval T(1), and in FIG. 5B a second mean wavelength T(2) can be directed at semiconducting substrate 112 during a second time interval λ(2).

In some embodiments, radiation source 114 directs radiation having energy greater than the bandgap energy of the semiconducting substrate to the semiconducting substrate, whereby gas contacting the substrate can be desorbed. For example, in FIG. 5C, optional third mean wavelength λ(3) (e.g., λ(3)<hc/E_{g}) can be directed at semiconducting substrate 112 during optional third time interval T(3). This desorbing interval can be conducted before a measurement, after a measurement, during a measurement employing multiple intervals, and the like. The desorbing interval can serve to refresh the sensor and can retain a stationary initial state between different sensing events to improve the reproducibility of the sensor. For example, the two-gas sensor depicted in FIG. 5A-C could operate a single or repeated sequence including a desorb interval (λ(3) for T(3)), a first gas detection interval (λ(1) for T(1)), another desorb interval(λ(3) for T(3)), a second gas detection interval (λ(2) for T(2)), and the like. One of ordinary skill in the art will appreciate that many variations are possible. For example, such a desorb interval can be implemented in the operation of each of the other sensor embodiments herein, for example, sensor embodiments 100 and 400, and the like.

In various embodiments, a selective gas sensor comprises a semiconducting substrate; a solid state radiation source integrated with the semiconducting substrate that directs narrowband radiation to the semiconducting substrate, and a plurality of electrodes coupled to the semiconducting substrate, whereby a gas is selectively sensed. The mean energy of the narrowband radiation can be less than the bandgap energy of the semiconducting substrate and the narrowband radiation can be selectively absorbed by a complex, the complex comprising the semiconducting substrate and the gas to be selectively sensed. In other embodiments, at least two gas sensing sites are included, wherein the electrodes are coupled to the semiconducting substrate to selectively sense at least one distinct gas at each site. In some embodiments, the semiconducting substrate can be SnO₂, TiO₂, ZnO, WO₃, Fe₂O₃, In₂O₃, Ga₂O₃, SrTiO₃, BaTiO₃, CdS, GaN, GaAs, or Si.

In various embodiments, a method of selectively sensing a gas comprises the steps of contacting a semiconducting substrate with a gas; directing narrowband radiation to the semiconducting substrate from a solid state radiation source integrated with the semiconducting substrate; and sensing or measuring the resistance of the semiconducting substrate, thereby selectively sensing the gas. The mean energy of the narrowband radiation can be less than the bandgap energy of the semiconducting substrate, and the narrowband radiation can be selectively absorbed by a complex, the complex comprising the semiconducting substrate and the gas. In other embodiments, the method includes sensing at least two distinct gases. In some embodiments, the method includes selecting the wavelength of the narrowband radiation to match an absorption maxima of a complex for each gas, each complex comprising a distinct semiconductor for each gas and the respective gas.

The sensor of the invention can be employed to sense any gas of interest in a vacuum, in a closed system having a background of other gases, in atmosphere, in space, and the like. For example, gases that can be sensed include H₂, O₂, O₃, H₂O, halogens (e.g., F₂, Cl₂, ClF₃, and the like), acids (e.g., HF, HCl, and the like), nitrogenous gases (e.g., NH₃, NOₓ, NF₃, and the like), hydrocarbon or carbonaceous gases (e.g., CO, CO₂, C1-C4 aliphatic gases such as CH₄, cyclopropane, cyclobutane, ethylene oxide, CH₂═CH₂, CH₂═C═CH₂, and the like), organic solvents (e.g., benzene, toluene, xylenes, tetrahydrofuran, acetone, diethyl ether, ethanol, methanol, and the like) halocarbons (e.g., C₂F₆, C₂HF₅, CF₄, C₃F₈, CHF₃, C₄F₈, CH₂F₂, C₃F₈, C₄F₈O, CH₃F, and the like), boronic gases (BF₃, BCl₃, B(CH₃)₃, and the like), silicon, germanium, and arsenic gases (e.g., SiF₄, SiCl₄, Si₂H₆, SiH₂Cl₂, SiH₃CH₃, SiHCl₃, GeF₄, AsH₃, AsF₅, and the like), sulfurous gases (H₂S, SO₂, SF₆, and the like), and metal halides (e.g., WF₆, and the like).

In some embodiments, a toxic gas is detected. As used herein, toxic gases include any gas known to the art to be injurious to health e.g., corrosives such as HCl, HF, and the like, oxidizers, e.g., F₂, and the like; chemical poisons such as CO, HCN, H₂S, and the like; gases injurious as a result of concentration, and the like.

In some embodiments, a combustible gas is detected. As used herein, a combustible gas is any gas that can burn or explode, typically in reaction with an oxidizing gas, e.g. H₂ burning in O₂ and the like. Combustible gases can include, for example, H₂, hydrocarbon or carbonaceous gases, gases associated with flammable solvents or fuels (e.g., gases or vapors emitted from petroleum and petroleum derived fuels), vapors of organic solvents (benzene, toluene, xylenes, tetrahydrofuran, acetone, diethyl ether, ethanol, methanol, and the like), hydrogen containing gases (ammonia, silanes, boranes, and the like) and the like.

In various embodiments, a gas is detected from a combustion process, e.g., in an exhaust stream from an internal combustion engine, an exhaust stream from a furnace, an open fire, and the like. Gases emitted by such processes are well known to the art and can include unburned fuels (derived from petroleum, coal, biomass, natural gas, and the like), products of combusted fuels (H₂O, CO, CO₂, and the like) products of nitrogen, e.g., nitrogen oxides; combusted products of contaminants in the fuel (e.g., sulfur oxides from coal or diesel containing sulfur), and the like.

In various embodiments, a gas is detected from a chemical process, for example any gas or vapor associated with a chemical process: e.g., reagents, solvents, and products in chemical synthesis; reagents, solvents, and products in semiconductor manufacturing; products of refining petroleum, coal, biomass, and the like; solvents in coating processes; and the like.

In various embodiments, a gas is detected from a bacterial process, for example any gas or vapor emitted by the action of bacteria, e.g., bacteria employed in bioreactors to produce chemicals or biochemicals, e.g., bacteria used in fermentation to produce ethanol; bacteria used to prepare consumable/food products (wine, beer, liquor, cheese, cured meats, and the like); bacteria in waste treatment; and the like. Gases or vapors emitted by such processes can include, for example, metabolic products such as ethanol, carbon dioxide, hydrogen sulfide, methane, ammonia, acetone, and the like

In various embodiments, a gas is detected from a food source, for example a gas emitted during food processing, storage, cooking, and the like.

In various embodiments, a gas is detected from a subject (e.g., humans, mice, rats, dogs, cats, monkeys, chimpanzees, chickens, pigs, cattle, sheep, and the like, typically humans) that is indicative of the subject's health. Such a gas can be any metabolic product, e.g., carbon dioxide, nitrogen dioxide, water, ethanol, acetone, methane, ammonia, hydrogen sulfide, acetaldehyde, and the like; or can be a gas which is used by the subject, e.g., oxygen; or can be a gas administered to a subject during medical treatment, e.g., oxygen or an anesthetic such as nitrous oxide; or can be a gas or metabolic product thereof associated with exposure of the subject to a toxic gas, e.g., carbon monoxide, hydrogen cyanide, and the like.

In various embodiments, a gas is detected to monitor indoor air quality, e.g., in environments such as vehicle cabins, e.g., automobiles, planes, trains, and the like; buildings, e.g., homes, industrial buildings, hospitals, laboratories, clean rooms, and the like.

In various embodiments, a chemical warfare agent, or a chemical precursor or decomposition product thereof is detected. Chemical warfare agents include, for example, nerve agents including tabun, sarin, soman, cyclohexyl methylphosphonofluoridate, methylphosphonothioic acid S-(2-(bis(1-methylethyl)amino)ethyl) O-ethyl ester), phosphonofluoridic acid, ethyl-, isopropyl ester), phosphonothioic acid, ethyl-, S-(2-(diethylamino)ethyl) O-ethyl ester), Amiton, phosphonothioic acid, methyl-, S-(2-(diethylamino)ethyl) O-ethyl ester) blister/vesicant Agents, e.g., lewisite, mustard-Lewisite, nitrogen mustards (HN-1, HN-2, HN-3), phosgene oxime, sulfur mustards (H, HD, HT); cyanogen chloride, hydrogen cyanide, chlorine, chloropicrin, diphosgene, phosgene, and the like. A chemical precursor includes gases or vapors known to the art to be used in the preparation of chemical warfare agents. A decomposition product includes gases or vapors known to the art to result from reaction or decomposition of a chemical warfare agent with oxygen, water, sunlight, biological tissue, and the like.

In various embodiments, a chemical indicative of a high explosive is detected. Such compounds include explosives themselves (e.g., trinitrotoluene, hexogen, octogen, pentaerythritol tetranitrate, triamino trinitrobenzene, and the like) and compounds emitted by the explosives, e.g., nitrogen oxides.

### EXEMPLIFICATION

While not wishing to be bound by theory, it can be helpful to understand the embodiments herein by considering a theoretical model which can be employed to estimate device performance, select appropriate device parameters and materials, and provide other guidelines for constructing the devices of the invention. Thus, it is to be understood that the material in this section and in the figures referenced therein when referring to the disclosed invention represent results calculated from the theoretical model rather than experimental data.

Thermally Activated Semiconductor Gas Sensors

The sensing mechanism of thermally activated semiconductor gas sensors is believed to involve charge transfer interactions with adsorbed gases that can lead to changes in electrical conductivity.

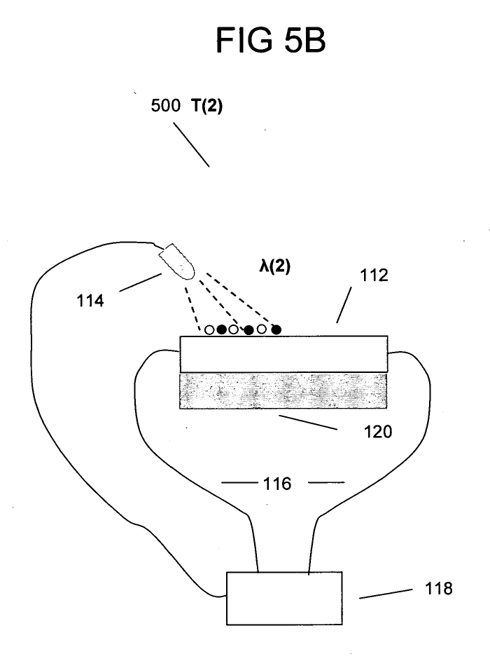

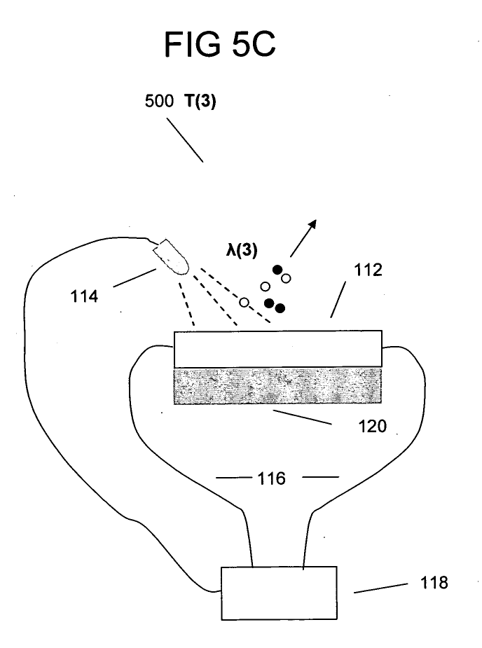

FIGS. 6A-C are schematic presentations of the effect of the ambient gas atmosphere on the energy band diagram of thermally activated semiconducting gas sensors: FIG. 6A, n-type semiconductor in clean air; FIG. 6B, n-type semiconductor with reducing gases in air; and FIG. 6C, n-type semiconductor with oxidizing gases in air.

Such an n-type semiconductor gas sensor can be, for example, SnO₂. Under thermal operation conditions, e.g., when the sensor is heated to 200-400° C. in ambient air, oxygen from the ambient atmosphere can adsorb on the surface and capture an electron from the conduction band to produce a chemisorbed oxygen adion, O_{(ad)}⁻:

$$\frac{1}{2} {O}_{2 ( g )} + {e}_{cb}^{-} ↔ {O}_{( ad )}^{-} . \qquad ( 1 )$$

As a result, the surface can become negatively charged and the energy bands can bend upwards, as shown in FIG. 6A. As long as the ambient gas composition and the sensor's temperature do not change, there can be a constant amount of oxygen adsorbate and the surface charge density, Nₛ⁻=[O_{(ad)}⁻], can remain constant.

However, if there is a change in the ambient gas composition (or temperature), e.g., when the sensor is exposed to reactive gases, the surface charge density can change. Exposure to reducing gases (FIG. 6B) (Re_{(g)}) such as CO, H₂, and CH₄, can decrease the surface charge density because these gases can interact with pre-adsorbed oxygen adions and can remove them from the surface:

$${Re}_{( g )} + {{O}_{( ad )}^{-} ( \to Re {O}_{{( ad )}^{*}}^{-} )}_{intermediate state} \to Re {O}_{( g )} + {e}_{cb}^{-} . \qquad ( 2 )$$

As a result, the energy bands can bend downwards, and the surface depletion layer can become narrower (with respect to the situation in clean air), as shown in FIG. 6A.

In contrast, exposure to oxidizing gases such as NOₓ or Cl₂ can increase the surface charge density, Nₛ⁻=[O_{(ad)}⁻]+[Ox_{(ad)}⁻], because these strong oxidizing agents can capture more electrons from the conduction band:
Ox_{(g)}+e_{cb}⁻→Ox_{(ad)}⁻ (3)

As a result, the surface region can become even more depleted of carriers, the energy bands can bend upwards, and the depletion region can extend deeper into the bulk, as shown in FIG. 6C.

In an uncontrolled gas atmosphere, various reducing and oxidizing gases can be present at different concentrations. In this case the surface charge density under steady state conditions can be represented by

$${N}_{s}^{-} = [ {O}_{( ad )}^{-} ] + {\sum }_{j} [ {Ox}_{( ad )}^{-} ] = \frac{{k}_{O}^{ads} {n}_{s} {p}_{{O}_{2}}^{1 / 2}}{{k}_{O}^{des} + {\sum }_{i} {k}_{{Re}_{i}} {p}_{{Re}_{i}}} + {\sum }_{j} {k}_{{Ox}_{j}} {n}_{s} {p}_{{Ox}_{j}}^{{m}_{j}} . \qquad ( 4 )$$

k_{O}^{ads} and k_{O}^{des} represent the rate constants for oxygen adsorption and desorption (Eq. 1), k_{Re}_{ᵢ} represents the rate constant for the oxidation of a reducing gas species Re_{(g),i} by pre-adsorbed oxygen adions (Eq. 2), and k_{Ox}_{ⱼ} represents the rate constant for the chemisorption of an oxidizing gas species Ox_{(g),j} (Eq. 3). Po₂, P_{Re}_{ᵢ}, and P_{Ox}_{ᵢ} represent the partial pressures of oxygen, the reducing gases Re_{(g),i}, and the oxidizing gases Ox_{(g),j}, respectively. nₛ represents the electron density in the conduction band at the surface. mⱼ=½ or 1 for dissociative or nondissociative adsorption processes, respectively.

Thus, the surface charge density can depend on the products of the gas concentrations and the corresponding reaction constants. It can increase with increasing concentrations of oxidizing gases and can decrease with increasing concentrations of reducing gases. Therefore, by monitoring the electrical conductivity, which can depend on variations in the surface charge density, the sign of the conductivity change can be correlated with whether the sensor was exposed to a reducing or oxidizing gas (with respect to a reference atmosphere, typically taken as clean air). In n-type gas sensors, increases in conductivity can indicate exposure to reducing gases whereas decreases in conductivity can indicate exposure to oxidizing gases. The situation is reversed for gas sensors made of p-type semiconductors.

However, in these prior art thermally activated semiconductor gas sensors, different gases belonging to the same group (oxidizing or reducing) typically cannot be distinguished unless the sensor is made selective to a specific gas. This means that the corresponding rate constant should be much larger for that gas than for all the other gases (in the same group), which can be very difficult to achieve by using conventional methods. This problem can be appreciated in that all the rate constants typically increase with increasing temperature; and in the temperature range where thermally activated semiconductor gas sensors are typically operated (200-400° C.) to insure adequate sensor response (and recovery) kinetics, the rate constants typically are non-negligible. Thus, thermally activated semiconductor gas sensors are believed to be inherently non-selective.

Broadband Photo-Activated Semiconductor Gas Sensors

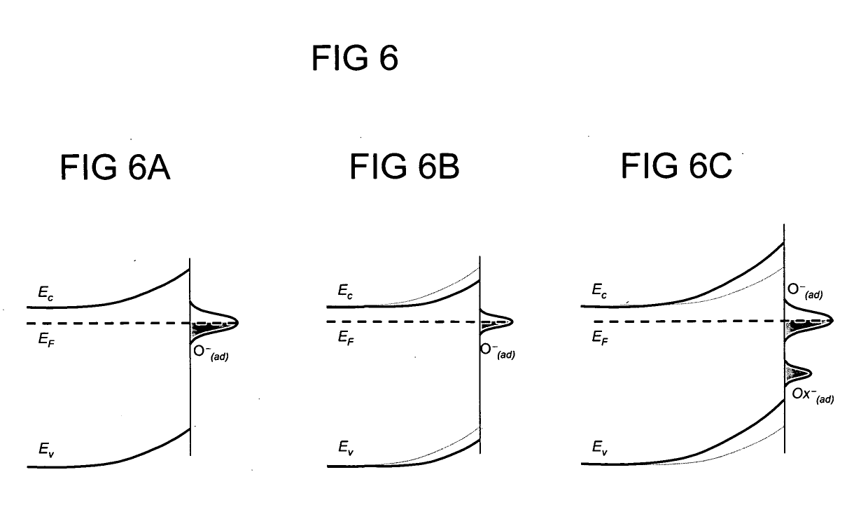

Previous studies (Comini, et al., “Light Enhanced Gas Sensing Properties of Indium Oxide and Tin Dioxide Sensors,” Sensors and Actuators B, 65: 260-263 (2000).; Comini, et al., “UV Light Activation of Tin Oxide Thin Films for NO₂ Sensing at Low Temperatures,” Sensors and Actuators B, 78: 73-77 (2001).; Comini, et al., “SnO/sub 2/RGTO UV Activation for CO Monitoring,” Sensors Journal, IEEE, Vol. 4, Issue 1: 17-20 (2004).; and Anothainart, K., et al., “Light Enhanced NO₂ Gas Sensing with Tin Oxide at Room Temperature: Conductance and Work Function Measurements,” Sensors and Actuators B, 93: 580-584 (2003).) employed broadband illumination from a mercury-xenon or a halogen lamp and demonstrated response of SnO₂ and In₂O₃ sensors to CO and NO₂ at ambient temperature, whereas the response of non-illuminated samples was negligible and very sluggish, as shown in FIG. 7 (Anothainart, K., et al., (2003), ibid.), which depicts gas response of SnO₂ to 100 ppm NO₂ with (right-hand-side) and without (left-hand-side) illumination at 25° C. and 0% relative humidity. Conductance (G) and contact potential difference (CPD) measurements are shown on the bottom and top curves, respectively. Although this work indicated that photoactivation could replace thermal activation of semiconductor gas sensors, broadband illuminated sensors are still typically not selective. The origin of the photostimulated response to CO and NO₂ has not been explained by the authors of (Comini, et al., (2000), ibid.; and Comini, et al., (2001), Comini, et al. (2004), ibid. and Anothainart, et al. (2003), ibid.), and there is a need to study these processes further in order to understand the underlying physics and chemistry.

These studies do indicate that photo-activation (of the response kinetics) can be more efficient than thermal-activation in terms of power consumption. Comini et al. (2004) found that the optimal broad band illumination power for CO-sensing using SnO₂ sensors at ambient temperature could be 15 mW/m². In comparison, Wöllenstein et al. (Wöllenstein, J., et al., “A Novel Single Chip Thin Film Metal Oxide Array,” Sensors and Actuators, 93: 350-355 (2003).). recently studied micro-arrays of 4 sensors on ca. 2×2 mm micromachined chips. The power to heat such a chip to a typical operation temperature of 321° C. is 300 mW, or 75 mW per sensor. This is almost ×20-times more power than what would be required in order to operate these sensors using light instead of heat.

Theory of Narrowband Radiation Activated Semiconductor Gas Sensors

At ambient temperature (typically about 25° C.), all rate constants can be small (compared to the rates at 200-400° C.) including that for the target gas analyte. The rate constant of the gas to be detected can be selectively promoted by narrowband radiation while the other rate constants can remain small. The narrowband radiation can be employed to selectively excite the energy level associated with the target gas analyte, or its complex with the semiconducting substrate.

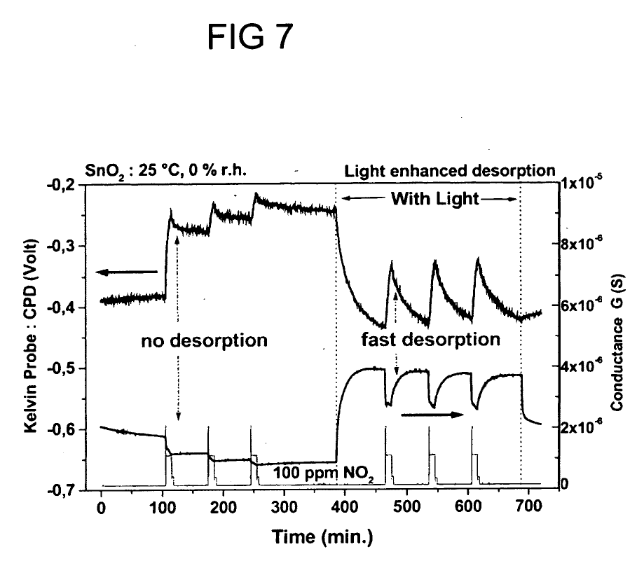

FIGS. 8A-C depicts schematic models of different routes in which photo-activation is believed to promote charge transfer interactions between the sensor and adsorbed gases (or intermediate species) that can eventually lead to a sensing signal. FIG. 8 depicts as an example an n-type semiconductor and various gas adsorbates. FIG. 8A shows super bandgap illumination (λ<hc/E_{g}) that leads to electron-hole separation in the surface depletion layer. FIG. 8B shows electron excitation from the valence band into an oxidizing state using narrowband illumination at sub-bandgap wavelengths (λ>hc/E_{g}). FIG. 8C shows electron excitation from an intermediate reducing state into the conduction band using narrowband illumination at sub-bandgap wavelengths (λ>hc/E_{g}).

In FIG. 8A, for example, irradiating the sensor with high energy photons (λ<hc/E_{g}, i.e., super bandgap illumination), typically using UV light, can generate electron-hole pairs. In the surface depletion regions, these pairs can be separated due to built-in electric field. The holes can drift towards the surface while the electrons can drift towards the bulk. Consequently, the surface band bending can become smaller as depicted in FIG. 8A. As a result of the reduction in the surface barrier, the electron trapped in the ReO_{(ad)*}⁻ intermediate state can be easily transferred to the sensor's conduction band, thereby promoting the reaction described by Eq. (2). Likewise, an electron from the conduction band can be easily captured by an oxidizing gas to form the Ox_{(ad)}⁻ surface state (since the surface barrier can become smaller), thereby promoting the reaction described by Eq. (3). Thus, super bandgap illumination can promote charge transfer interactions between the sensor and adsorbed gases by lowering the surface barrier, or in other words the activation energy. As a results, these interactions can occur (at a reasonable rate) at lower temperatures than in dark conditions, where thermal activation is typically necessary to promote them. In addition, when the exposure to the oxidizing gas Ox_{(g)} can be terminated, the super bandgap illumination can promote desorption of the Ox_{(ad)}⁻ adsorbates by surface recombination with photo-generated holes. This can facilitate the recovery of the sensor and can produce a reproducible response.

However, illumination with high energy photons (λ<hc/E_{g}) is not believed to be suitable for tuning the selectivity of the sensor to specific gases because it can typically increase the rate constants of all gas/sensor interactions. In other words, super bandgap illumination (λ<hc/E_{g}) is believed to be non-selective.

In contrast, sub-bandgap (i.e., λ>hc/E_{g}) narrowband irradiation can be suitable for tuning the selectivity because it is believed to promote specific interactions with certain gas adsorbates while not affecting the other ones. For example, the photocatalytic efficiency, or in other words the number of photocatalyzed species per incident photon with a given wavelength, can be proportional to the absorbance of light at that wavelength (Emeline, A., et al., “Spectral Dependence and Wavelength Selectivity in Heterogeneous Photocatalysis. I. Experimental Evidence from the Photocatalyzed Transformation of Phenols,” J. Phys. Chem. 104(47): 11202-11210 (2000).). The latter can depend on the joint density of states between the initial and final electronic states corresponding to the respective photon energy, (Toyozawa, Y., Optical Processes in Solids (Cambridge University Press, Cambridge) 2003.) which can be different for different gas/semiconductor complexes.

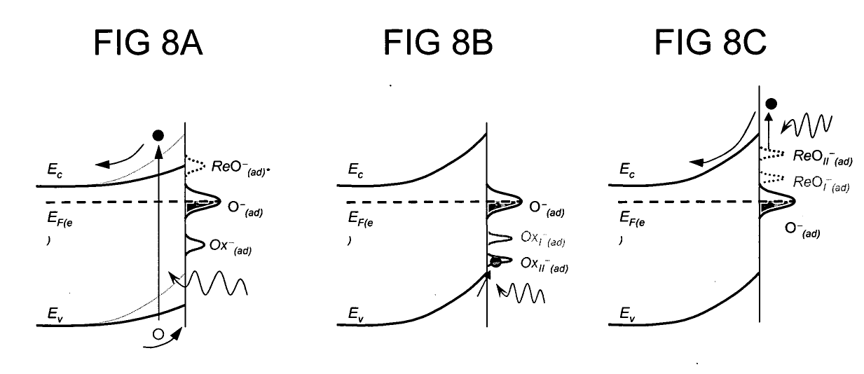

FIGS. 9A and 9B are respective schematic illustrations of the joint density of states for two different gas adsorbates (Ox_{(ad)}^{I} and Ox_{(ad)}^{II}) at two different wavelengths (I and II). The length of the arrows represents the photon energy, and the shaded area is proportional to the joint density of states. These states can represent two different gas adsorbates (on the same substrate). The figure shows that at a given wavelength the joint density of states associated with these adsorbates can be different for each species, as determined by the energy level of these states. Thus, for one wavelength the photocatalytic efficiency can favor one species (e.g., the Ox_{(ad)}^{I} in case I) whereas for another wavelength it can favor another species (e.g., the Ox_{(ad)}^{II} in case II). Consequently, the photo-induced sensitivity to different gases can depend on the wavelength of the irradiated light, and the selectivity can be tuned by controlling this parameter.

Recently, Emeline et al. studied the spectral-dependent efficiency and selectivity of some heterogeneous photocatalytic reactions on wide bandgap metal-oxides (serving as catalysts, not sensors) (Emeline, A. V., et al., “Spectral Dependencies of the Quantum Yield of Photochemical Processes on the Surface of Wide Band Gap Solids. 3. Gas/Solid Systems,” J. Phys. Chem. 104(14): 2989-2999 (2000).; and Emeline, V., et al., “Spectral Selectivity of Photocatalyzed Reactions Occurring in Liquid-Solid Photosystems,” J. Phys. Chem. 106(47):12221-12226 (2002).). They found that in some cases the photocatalytic efficiency can favor certain reactions with specific reactants whereas in other cases it can be non-selective.

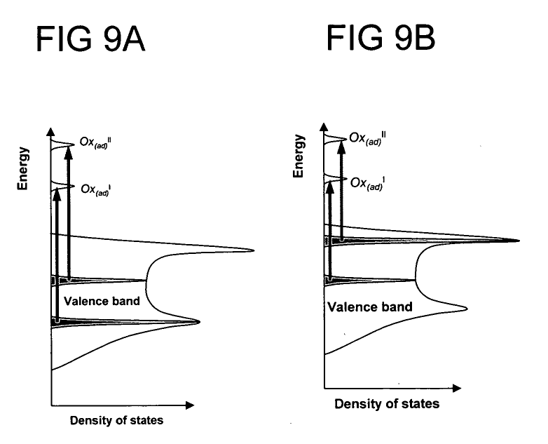

For example, FIGS. 10A and 10B depict spectral dependence of the quantum yield of photoadsorption of oxygen (1); hydrogen (2), and methane (3) on (FIG. 10A) TiO₂ and (FIG. 10B) CeO₂. The photoadsorption of oxygen was studied at T=100 K, whereas hydrogen and methane at T=293 K. The corresponding spectra can have the same shape in the case of CeO₂, and the differences between them are typically not large. Thus, CeO₂ can be relatively non-selective between these photo-assisted reactions. In contrast, in the case of TiO₂, the spectra can have different shapes. At hv≈3 eV the quantum yield can be nearly the same for photoadsorption of hydrogen and methane, while at hv≈4.5 eV it can be four times larger for methane than for hydrogen.

Although the results of Emeline et al. were for catalysts and not sensors, the results can be exploited in the disclosed semiconductor gas sensors to construct, for example, a simple array of two TiO₂ sensors; one illuminated with 3 eV photons (sensor A) and the other with 4.5 eV photons (sensor B). Such an array can easily discriminate between hydrogen and methane. In case of exposure to hydrogen both sensors can yield about the same response, whereas exposure to methane can yield a much stronger (×4) response of sensor B with respect to sensor A. Thus, the sensor array can selectively detect the two gases. This can be adapted to other pairs of gases, and expanded to multi-sensor arrays that can selectively detect (and discriminate) multiple gases, gas mixtures, different smells, and the like.

Calibration, Operation, Materials Selection, & Construction

Operation of the disclosed semiconductor gas sensors can benefit from characterization of the surface electronic properties of both n- and p-type semiconductor substrates in (clean) air and under exposure to different reducing and oxidizing gases. The energy levels of the adsorbed gases and/or their intermediate states are believed to be important in the photo-induced sensing mechanism, e.g., they are believed to determine which species can be highly activated by illumination with a certain wavelength while other species are not. Surface Photovoltage Spectroscopy (SPS) can be used as a primary tool for these characterizations due to its high sensitivity to the surface electronic properties of semiconductors (Kronik, L., et al., “Surface Photovoltage Phenomena Theory, Experiment, and Application,” Surface Science Reports, 37: 1-206 (1999).; Kronik, L., et al., “Surface Photovoltage Spectroscopy of Semiconductor Structures: at the Crossroads of Physics, Chemistry and Electrical Engineering,” Surf Interface Anal., 31: 954-965 (2001).; and Schroder, D. K., “Contactless Surface Charge Semiconductor Characterization,” Materials Science and Engineering, 91-92: 196-210 (2002).; and Schroder, D. K., “Surface Voltage and Surface Photovoltage History, Theory and Applications,” Meas. Sci. Technol. 12: R16-R31 (2001).) Lagowski, et al. have pioneered the use of SPS as a highly effective tool for characterizing adsorbate states on CdS, (Lagowski, J., et al., “Determination of Surface State Parameters from Surface Photovoltage Transients:CdS,” Surface Science, 29: 203-212 (1972).; and Gatos, H. C., et al., “Surface Photovoltage Spectroscopy—A New Approach to the Study of High-Gap Semiconductor Surfaces,” J. Vac. Sci. Technol. 10: 130-135 (1973).) ZnO, (Lagowski, J., et al., “Quantitative Study of the Charge Transfer in Chemisorption; Oxygen Chemisorption on ZnO,” J. Appl. Phys., 48: 3566-3575 (1977).; and Lagowski, J., et al., “Charge Transfer in ZnO Surfaces in the Presence of Photosensitizing Dyes,” J. Appl. Phys., 49: 2821-2826 (1978).) and GaAs, (Lagowski, J., et al., “Derivative Surface Photovoltage Spectroscopy; A New Approach to the Study of Absorption in Semiconductors: GaAs,” J. Appl. Phys., 50: 5059-5061 (1979).) while more recently, Rothschild et al. used this method to study oxygen chemisorption and gas sensing properties of TiO₂ films (Rothschild, A., et al., “Surface Photovoltage Spectroscopy Study of Reduced and Oxidized Nanocrystalline TiO₂ Films,” Surface Science, 532-535 (2003) 456-460.; and Rothschild, A., et al., “Electronic and Transport Properties of Reduced and Oxidized Nanocrystalline TiO₂ Films,” Appl. Phys. Lett., 82(4): 574-576 (2003).).

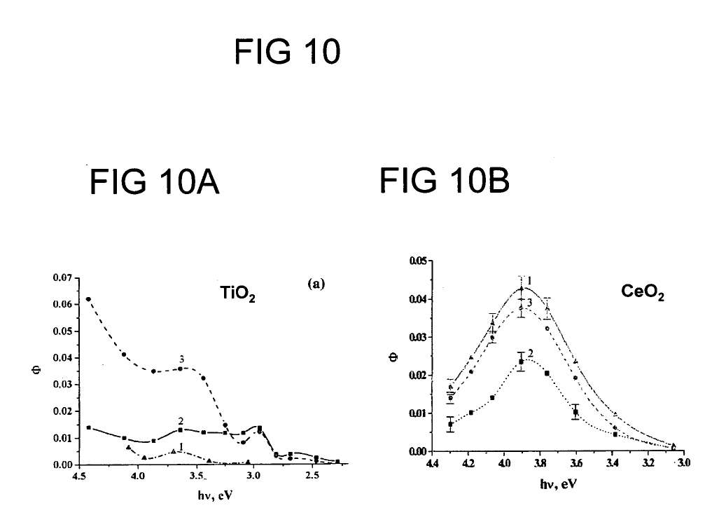

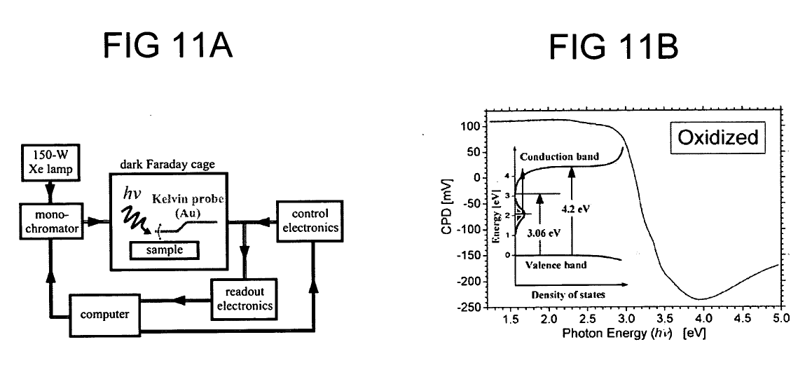

FIG. 11A shows a Kelvin probe apparatus in an environmental chamber that carries out Surface Photovoltage Spectroscopy (SPV) measurements under controlled gas atmospheres. The contact potential difference (CPD) between the sample and a reference probe of a known work function can be measured using the Kelvin probe technique (Kronik, L., et al., (1999), ibid.; Kronik, L., et al., (2001), ibid.; and Schroder, D. K., (2002), ibid.; and Schroder, D. K., (2001), ibid.). In this configuration the reference probe is vibrating close to the surface of the sample and shorted to its backside, thus forming a capacitor configuration between the probe and sample. The vibrations induce an alternating current unless a voltage is applied between the probe and sample to compensate for the difference between their work functions. The negative value of the applied voltage is therefore the CPD. The CPD is measured in dark conditions and under monochromatic illumination scanning the spectral range of interest. The surface photovoltage (SPV) is the difference between the CPD in dark minus the CPD in light with a given wavelength. The SPV spectrum as a function of the photon energy of the incident light can be used to characterize the energy levels of surface states, which usually appear as distinct features in the otherwise flat sub-bandgap range of the SPV spectrum.

FIG. 11A also shows a typical Kelvin probe apparatus. The energy levels of different gas adsorbates can be characterized with a Kelvin probe able to operate in controlled atmosphere and elevated temperature (e.g., KP-6000 Digital Kelvin Probe, McAllister Technical Services, Coeur d'Alene, ID, or Kelvin Probe S with Kelvin Control 07, Besocke Delta Phi, Jülich, Germany). Depending on experimental conditions, the unit will be capable of resolving approximately 10 meV, sufficient for determining relative energy levels of adsorbed species. The surface can be illuminated with light of controlled wavelength using a broadband light source (e.g., mercury, xenon, or halogen lamp) coupled to a monochromator (e.g., Cornerstone 260¼ m Motorized Monochromator, Oriel, Stratford, Conn.).

FIG. 11B shows an SPV spectrum of an oxidized TiO₂ film and the interpretation of the results in terms of a simplified energy band diagram (Rothschild, A., et al., (2003), ibid.; Rothschild, A., et al., (2003), ibid.).

In addition to SPS measurements that can be carried out in-situ under controlled gas atmospheres, X-ray Photoelectron Spectroscopy (XPS) and Ultraviolet Photoelectron Spectroscopy (UPS) measurements can also be carried out ex-situ under vacuum conditions. These methods are particularly useful for studying the band structure and density of states of various materials (Hüfner, S., Photoelectron Spectroscopy: Principles and Applications, 3^{rd} Ed. (Berlin: Springer) (2003).). They can be used to characterize the (intrinsic) band structure and density of states of the sensor material itself, while the (extrinsic) surface states associated with gas adsorbates can be studied using SPS.

When the energy levels of different gas adsorbates with respect to the band edges of the semiconductor sensor are identified as above, suitable wavelengths for photo-excitation of the states of the adsorbed complexes can be determined, and the corresponding sensors of the invention can be constructed for those gases. Preliminary calibrations can be performed using direct current (DC) conductivity measurements to monitor the conductivity change as a function of time upon cyclic exposure of the sensor to various gases in a controlled gas atmosphere. These standard gas sensing tests can give valuable information such as the sensitivity, response time, recovery time, reproducibility, and drift. The sensitivity can be defined as the conductivity in steady state conditions when the sensor is exposed to the target gas analyte, normalized to the conductivity value in the background gas atmosphere, which is normally taken as clean air with or without a given amount of humidity.

These sensing calibration tests can be run at ambient temperature and also at elevated temperatures, and compared to the response in dark conditions with the response under controlled illumination. The objective of these measurements is to calibrate the ability of the disclosed semiconductor gas sensors to operate selectively at ambient temperature using controlled illumination with the appropriate wavelength and intensity.

While this invention has been particularly shown and described with references to preferred embodiments thereof, it will be understood by those skilled in the art that various changes in form and details may be made therein without departing from the scope of the invention encompassed by the appended claims.

The entire teachings of each reference cited herein is incorporated by reference.

What is claimed is:

1. A selective gas sensor, comprising:
a semiconducting substrate;
a narrow band radiation source that directs narrowband radiation to the semiconducting substrate, wherein the mean energy of the narrowband radiation is less than the bandgap energy of the semiconducting substrate;
a plurality of electrodes coupled to the semiconducting substrate,
whereby a gas is selectively sensed; and
a controller that sequentially directs distinct narrow band radiation to the semiconductor substrate and measures the resistance of the substance through the electrodes, whereby distinct gases are sensed as a function of time.

2. The sensor of claim 1, wherein the semiconducting substrate includes an inorganic semiconductor selected from family II-VI, III-V semiconductors;
column IV semiconductors; metal oxides; sulfides, selenides, and nitrides.

3. The sensor of claim 2, wherein the semiconducting substrate includes an inorganic semiconductor selected from CdTe, CdSe, CdS, ZnS, GaAs, GaN, AlGaN, InGaN, GaP, InP, InAsP, Si, Ge, ZnO, SnO₂, TiO₂, Cr₂, TiO₃, WO₃, SiC, MoO₃, Fe₂O₃, In₂O₃, Ga₂O₃, SrTiO₃, BaTiO₃, CaTiO₃, (La,Sr)FeO₃, and (La,Sr)CoO₃.

4. The sensor of claim 3, wherein the semiconducting substrate is SnO₂, TiO₂, ZnO, WO₃, Fe₂O₃, In₂O₃, Ga₂O₃, SrTiO₃, BaTiO₃, CdS, GaN, or Si.

5. The sensor of claim 1, wherein the semiconducting substrate includes an organic semiconductor selected from carbon nanotubes, fullerenes, polyacetylene, polythiophene, polyphenylene, poly(para-phenylene)vinylene, poly(para-pyridyl)vinylene, polyaniline, and polypyrrole.

6. The sensor of claim 1, wherein the narrowband radiation source is integrated with the semiconducting substrate.

7. The sensor of claim 1, wherein at least about 95% of the narrowband radiation has an energy less than the bandgap energy of the semiconducting substrate.

8. The sensor of claim 1, wherein the narrowband radiation is selectively absorbed by a complex, the complex comprising the semiconducting substrate and the gas to be selectively sensed.

9. The sensor of claim 8, wherein the narrowband radiation source is a narrowband filter coupled to a broadband radiation source.

10. The sensor of claim 8, wherein the narrowband radiation source is a solid state device.

11. The sensor of claim 10, wherein the narrowband radiation source is a laser.

12. The sensor of claim 10, wherein the narrowband radiation source is a light emitting diode.

13. The sensor of claim 1, further including at least two gas sensing sites, wherein the electrodes are coupled to the semiconducting substrate to selectively sense at least one distinct gas at each site.

14. The sensor of claim 13, further including a distinct semiconductor composition at each gas sensing site.

15. The sensor of claim 13, further including a distinct catalyst composition at each gas sensing site.

16. The sensor of claim 13, wherein the narrowband radiation source directs distinct narrowband radiation to each gas sensing site.

17. The sensor of claim 13, further comprising an array of gas sensing sites.

18. The sensor of claim 1, wherein the narrowband radiation source directs radiation having energy greater than the bandgap energy of the semiconducting substrate to the semiconducting substrate, whereby gas contacting the substrate can be desorbed.

19. A method of selectively sensing a gas, comprising the steps of:
contacting a semiconducting substrate that is coupled to a plurality of electrodes with a gas having distinct gas components;
sequentially directing distinct narrowband radiation to the semiconducting substrate, wherein the mean energy of the narrowband radiation is less than the bandgap energy of the semiconducting substrate; and
measuring the resistance of the substrate through the electrodes, whereby the distinct gases are sensed as a function of time.

20. The method of claim 19, wherein the semiconducting substrate includes an inorganic semiconductor selected from family II-VI, III-V or column IV semiconductors/insulators; metal oxides; and metal nitrides.

21. The method of claim 20, wherein the semiconducting substrate includes a semiconductor selected from CdTe, CdSe, ZnS, AlGaN, InGaN, GaP, InP, InAsP, Ge, Cr₂₋ₓTiₓO₃, SiC, MoO₃, CaTiO₃, (La,Sr)FeO₃, (La,Sr)CoO₃, SnO₂, TiO₂, ZnO, WO₃, Fe₂O₃, In₂O₃, Ga₂O₃, SrTiO₃, BaTiO₃, CdS, GaN, GaAs, and Si.

22. The method of claim 21, wherein the semiconducting substrate is SnO₂, TiO₂, ZnO, WO₃, Fe₂O₃, In₂O₃, Ga₂O₃, SrTiO₃, BaTiO₃, CdS, GaN, GaAs, or Si.

23. The method of claim 21, wherein the semiconducting substrate includes an organic semiconductor selected from carbon nanotubes, fullerenes, polyacetylene, polythiophene, polyphenylene, poly(para-phenylene)vinylene, poly(para-pyridyl)vinylene, polyaniline, and polypyrrole.

24. The method of claim 19, further including directing the narrowband radiation to the semiconducting substrate from a narrowband radiation source that is integrated with the semiconducting substrate.

25. The method of claim 19, wherein at least about 95% of the narrowband radiation has an energy less than the bandgap energy of the semiconducting substrate.

26. The method of claim 19, further including selecting the wavelength of the narrowband radiation to match an absorption maxima of a complex, the complex comprising the semiconducting substrate and the gas that is selectively sensed.

27. The method of claim 26, further including filtering the narrowband radiation from a broadband radiation source.

28. The method of claim 26, further including directing the narrowband radiation from a solid state narrowband radiation source.

29. The method of claim 28, further including directing the narrowband radiation from a laser.

30. The method of claim 28, further including directing the narrowband radiation from a light emitting diode.

31. The method of claim 19, further including sensing each distinct gas at a distinct gas sensing site.

32. The method of claim 19, wherein each distinct gas sensing site includes a distinct semiconductor.

33. The method of claim 19, further including directing distinct narrowband radiation to each distinct gas sensing site.

34. The method of claim 33, further including selecting the wavelength of the narrowband radiation for each site to match an absorption maxima of a complex, the complex comprising the distinct semiconductor at each distinct gas sensing site and the distinct gas that is selectively sensed at that site.

35. The method of claim 34, further including detecting the distinct gases with an array of distinct selective gas sensing sites.

36. The method of claim 19, further including directing to the semiconducting substrate radiation having photon energy greater than the bandgap energy of the semiconducting substrate, thereby desorbing gas contacting the substrate.

37. The method of claim 19, further including detecting carbon monoxide in a background of hydrogen.

38. The method of claim 19, further including detecting a toxic gas.

39. The method of claim 19, further including detecting a combustible gas.

40. The method of claim 19, further including detecting a gas in an exhaust stream from an internal combustion engine.

41. The method of claim 19, further including detecting a gas in an exhaust stream from a smokestack.

42. The method of claim 19, further including detecting a gas from a chemical process.

43. The method of claim 19, further including detecting a gas from a fermentation process.

44. The method of claim 19, further including detecting a gas from a food source.

45. The method of claim 44, further including detecting a gas from a food processing source.

46. The method of claim 19, further including detecting a gas from a subject that is indicative of the subject's health.

47. The method of claim 19, further including detecting a gas to monitor indoor air quality.

48. The method of claim 19, further including detecting a chemical warfare agent, or a chemical precursor or decomposition product thereof.

49. The method of claim 19, further including detecting a chemical indicative of a high explosive.

50. A selective gas sensor, comprising:
a semiconducting substrate;
a solid state narrowband radiation source integrated with the semiconducting substrate that directs narrowband radiation to the semiconducting substrate, wherein
the mean energy of the narrowband radiation is less than the bandgap energy of the semiconducting substrate;
the narrowband radiation is selectively absorbed by a complex, the complex comprising the semiconducting substrate and the gas to be selectively sensed; and
a plurality of electrodes coupled to the semiconducting substrate, whereby a gas is selectively sensed; and
a controller that sequentially directs distinct narrowband radiation to the semiconductor substrate and measures radiation through the electrodes, whereby distinct gases are sensed as a function of time.

51. The sensor of claim 50, further including at least two gas sensing sites, wherein the electrodes are coupled to the semiconducting substrate to selectively sense at least one distinct gas at each site.

52. The sensor of claim 50, wherein the semiconducting substrate is SnO₂, TiO₂, ZnO, WO₃, Fe₂O₃, In₂O₃, Ga₂O₃, SrTiO₃, BaTiO₃, CdS, GaAs, GaN, or Si.

53. A method of selectively sensing a gas, comprising the steps of:
contacting a semiconducting substrate that is coupled to a plurality of electrodes with a gas having distinct gas components;
sequentially directing distinct narrowband radiation to the semiconducting substrate from a solid state narrowband radiation source integrated with the semiconducting substrate, wherein
the mean energy of the narrowband radiation is less than the bandgap energy of the semiconducting substrate;
the narrowband radiation is selectively absorbed by a complex, the complex comprising the semiconducting substrate and the gas; and
measuring the resistance of the substrate through the electrodes, whereby the distinct gases are sensed as a function of time.

54. The method of claim 53, further including selecting the wavelength of the narrowband radiation to match an absorption maxima of a complex for each gas, each complex comprising a distinct semiconductor for each gas and the respective gas.
